(19) United States
(12) Patent Application Publication
(10) Pub. No.: US 2020/0161821 A1
(43) Pub. Date: May 21, 2020

(54) METHOD FOR MANUFACTURING ELECTRICAL CONNECTION COMPONENT

(71) Applicant: Yazaki Corporation, Tokyo (JP)

(72) Inventor: Hiroki KAWAI, Shizuoka (JP)

(73) Assignee: Yazaki Corporation, Tokyo (JP)

(21) Appl. No.: 16/684,872

(22) Filed: Nov. 15, 2019

(30) Foreign Application Priority Data
Nov. 21, 2018 (JP) 2018-218003

(51) Int. Cl. H01R 43/048; H01R 13/03; H01R 43/02; H01R 4/18

(52) U.S. Cl. CPC H01R 43/048; H01R 4/187; H01R 43/0221; H01R 13/03

(57) ABSTRACT

Provided is a method for manufacturing an electrical connection component, the method including forming a graphene-containing carbon film on the electrical connection component under heating by irradiation of laser light, on a region where the contact point part will be formed or has been formed, but outside of a region where the elastic part and the crimping part will be formed or have been formed. The electrical connection component has at least either one of an elastic part or a crimping part, and a contact point part.

### CROSS REFERENCE TO RELATED APPLICATION

This application is based upon and claims the benefit of priority from the prior Japanese Patent Application No. 2018-218003, filed on Nov. 21, 2018, the entire contents of which are incorporated herein by reference.

### BACKGROUND

### 1. Technical Field

The present disclosure relates to a method for manufacturing an electrical connection component.

### 2. Background Art

Connector terminal is required to satisfy high reliability of contact with mating terminal, and high wear resistance at connection point with the mating terminal. The contact point part of the connector terminal with the mating terminals is usually plated with a noble metal such as gold, silver or tin.

Noble metal is however expensive and pushes up the production cost of the connector terminal. It has therefore been proposed to cover the connector terminal with graphene, in place of plating the connector terminal with a noble metal.

For example, JP-A-2018-56119 discloses an electrical contact point. The electrical contact point is manufactured by using an electrical contact material having a substrate composed of a metal material having a resistivity of 1.59×10⁻⁸ Ωm or larger and 9.00×10⁻⁷ Ωm or smaller, and by forming thereon a layer composed of a carbon material. The carbon material is a graphene monolayer, or a multilayered graphene composed of a plurality of graphene monolayers stacked therein.

JP-A-2016-23128 discloses an apparatus for manufacturing a graphene film. The apparatus for manufacturing a graphene film has a plasma generating device that generates a plasma in a process chamber, and a Joule heating device that heats, by Joule heating, a metal substrate on which a graphene film is formed, placed in the process chamber. The apparatus for manufacturing a graphene film also has a vapor antiscattering device arranged so as to shade the metal substrate in order to prevent vapor emitted from the metal substrate under Joule heating from being scattered within the process chamber.

### SUMMARY

Now the contact point part of the mating terminal is fixed on the connector terminal, with the aid of elastic force exerted by an elastic body of the connector terminal. A cable connected to the connector terminal is crimped by a crimping part of the connector terminal, and is fixed to the connector terminal.

Graphene is typically formed into a film by thermal CVD (chemical vapor deposition) that thermally decomposes methane gas, as a starting material, at approximately 1000° C. Meanwhile, JP-A-2018-56119 describes formation of a carbon material layer at low temperatures, by microwave-assisted surface wave plasma CVD. Also JP-A-2016-23128 describes plasma-assisted formation of the graphene film at low temperatures.

Even with such prior methods, a copper alloy forming the connector terminal may have modified characteristics while being affected by such heating process. Hence, even the heating process by the prior methods may reduce the elastic force of the elastic body of the connector terminal, or reduce the crimp strength exerted on the cable at the crimping part of the connector terminal, possibly degrading the contact reliability of the connector terminal.

Alternatively, provision of a mechanism enhancing the elastic force to the connector terminal tends to make structure of the connector terminal more complicated. Still alternatively, thickening of a plate forming the connector terminal, aiming at enhancing the elastic force or crimp strength, tends to oversize the connector terminal.

The present disclosure was made considering the problems inherent to the prior art. It is therefore an object of the present disclosure to provide a method for manufacturing an electrical connection component capable of improving contact reliability as compared with the prior methods.

According to a first aspect of the present disclosure, there is provided a method for manufacturing an electrical connection component, wherein the electrical connection component includes at least either one of an elastic part or a crimping part, and a contact point part. The elastic part has elasticity, and is provided so as to fix a mating connection component to be connected to the electrical connection component onto the electrical connection component, making use of elastic force attributable to the elasticity. The crimping part is provided so as to crimp and fix a cable that is connected to the electrical connection component. The contact point part is provided so as to be electrically connected to the mating connection component. The method includes forming a graphene-containing carbon film on the electrical connection component under heating by irradiation of laser light, on a region where the contact point part will be formed or has been formed, but outside of a region where the elastic part and the crimping part will be formed or have been formed.

According to a second aspect of the present disclosure, there is provided a method for manufacturing an electrical connection component according to the first aspect, wherein the electrical connection component is either one of a female connector terminal or a male connector terminal. The mating connection component is a male connector terminal if the electrical connection component is the female connector terminal, and is a female connector terminal if the electrical connection component is the male connector terminal.

According to a third aspect of the present disclosure, there is provided the method for manufacturing an electrical connection component according to the second aspect, wherein the female connector terminal has the contact point part and the elastic part, and the male connector terminal has the contact point part and the crimping part.

The present disclosure can provide a method for manufacturing an electrical connection component capable of improving the contact reliability, as compared with the prior methods.

### BRIEF DESCRIPTION OF THE DRAWINGS

FIG. 1 is a perspective view illustrating an exemplary cable with terminal having a female connector terminal and a cable crimped thereon;

FIG. 2 is a perspective view illustrating a blank for forming the female connector terminal;

FIG. 3 is a cross-sectional view taken along line in FIG. 1;

FIG. 4 is a cross-sectional view taken along line IV-IV in FIG. 3;

FIG. 5 is a cross-sectional view illustrating an exemplary state of a male connector terminal inserted into the female connector terminal;

FIG. 6 is a side elevation illustrating an exemplary cable with terminal having a male connector terminal and a cable crimped thereon;

FIG. 7 is a top view illustrating an exemplary cable with terminal having a male connector terminal and a cable crimped thereon;

FIG. 8 is a perspective view illustrating a state that the cable has not been crimped yet onto the female connector terminal;

FIG. 9 is a top view illustrating a process of forming a carbon film by irradiating laser light on the contact point part of the female connector terminal; and

FIG. 10 is a top view illustrating a process of forming a carbon film by irradiating laser light on the contact point part of the male connector terminal.

### DETAILED DESCRIPTION

A detailed description will hereinafter be given of the method for manufacturing an electrical connection component according to an embodiment, with consultation of drawings. Note that the proportion of the drawings is exaggerated for the convenience of explanation, and may occasionally be different from the actual proportion.

This embodiment relates to a method for manufacturing an electrical connection component. The electrical connection component is typically an electrical part that can be electrically connected to a mating electrical part. The electrical connection component is not specifically limited so long as it can demonstrate the effect of this embodiment. The electrical connection component typically includes connector terminals such as female connector terminal and male connector terminal, card edge connector, ring terminal, and U-shape terminal, all will be described later. The connector terminal, as an exemplary embodiment, will be explained below.

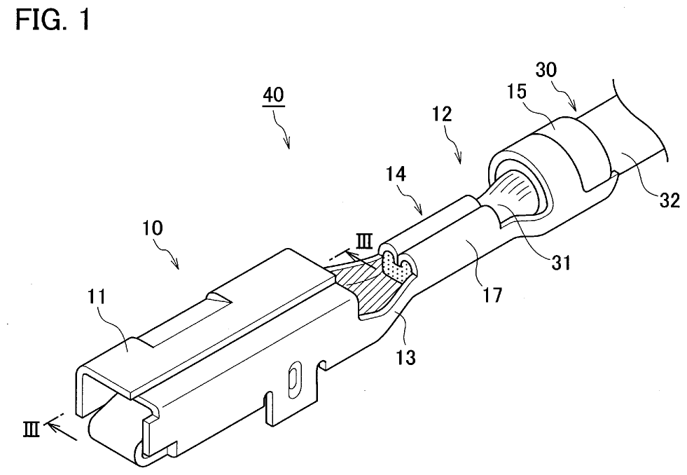

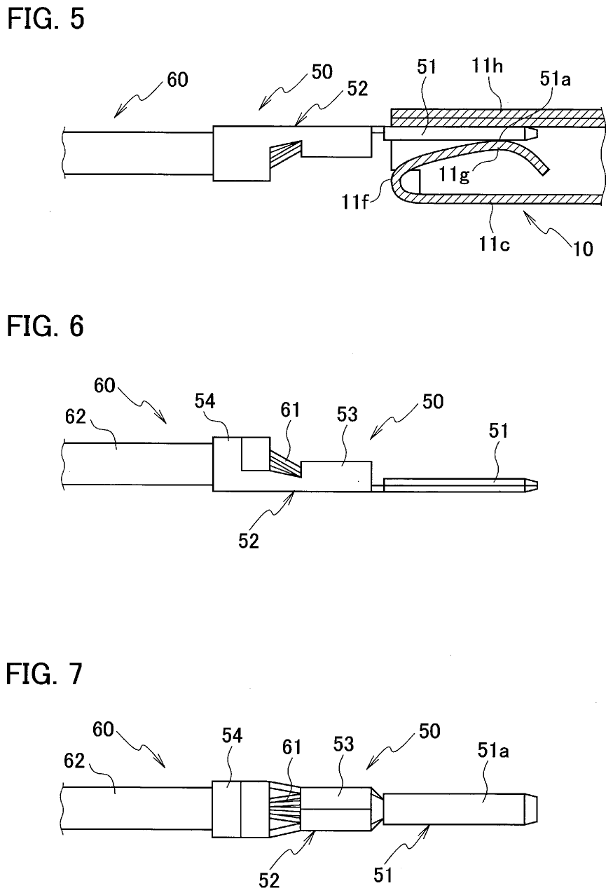

FIG. 1 is a perspective view illustrating an exemplary cable with terminal 40 having a female connector terminal 10 and a cable 30 crimped thereon. As illustrated in FIG. 1, the female connector terminal 10 has a connection part 11, crimping part 12, and an intermediate part 13 that connects the connection part 11 and the crimping part 12. The connection part 11 is provided at one end of the female connector terminal 10, and the crimping part 12 is provided at other end of the female connector terminal 10. The connection part 11 is provided so as to be electrically connected to a male connector terminal 50 (mating connection component) (see FIG. 5).

Within the cable with terminal 40, the crimping part 12 crimps and fixes a cable 30 that is connected to the female connector terminal 10. The crimping part 12 has a conductor crimping part 14 that crimps a conductor 31 of the cable 30, and a sheath crimping part 15 that crimps a cable sheath 32 of the cable 30. A method for crimping the cable 30 with the crimping part 12 will be described later.

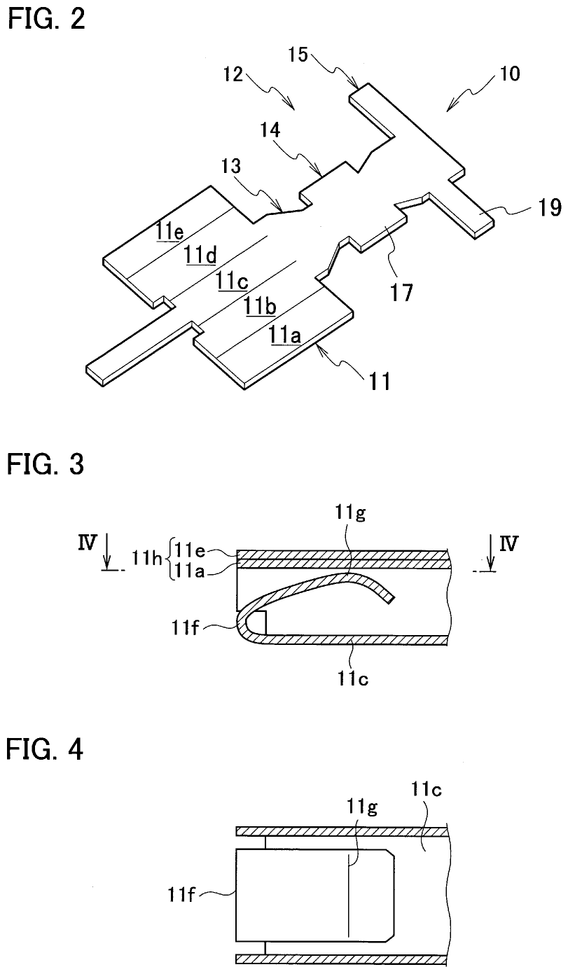

Next, a method for forming the female connector terminal 10 will be explained referring to FIGS. 1 and 2. FIG. 2 is a perspective view illustrating a blank for forming the female connector terminal 10. FIG. 1 is a perspective view illustrating the female connector terminal 10 formed from a blank. Reference signs in FIG. 2 denote portions corresponded to constituent elements of the female connector terminal 10 after being bent up.

As illustrated in FIG. 2, the female connector terminal 10 is bent up from a single blank punched out from a metal sheet, and is integrally made up of the connection part 11, crimping part 12 and the intermediate part 13. Note, however, that the female connector terminal 10 may be made up by combining the connection part 11, crimping part 12 and the intermediate part 13, all being separate components.

The blank may be formed of a metal. That is, the female connector terminal 10 may be formed of a metal. Material for forming the female connector terminal 10 preferably contains at least one metal selected from the group consisting of copper, copper alloy, aluminum, aluminum alloy, iron, iron alloy, magnesium and magnesium alloy.

FIGS. 3 and 4 are drawings illustrating the connection part 11 formed by bending the blank illustrated in FIG. 2. More specifically, FIG. 3 is a cross-sectional view taken along line III-III in FIG. 1. FIG. 4 is a cross-sectional view taken along line IV-IV in FIG. 3. As illustrated in FIGS. 2 to 4, the connection part 11 has a first upper wall 11a, a first side wall 11b, a bottom wall 11c, a second side wall 11d, and a second upper wall 11e. These walls are formed by a bending process so as to give a nearly square cross-sectional shape of the female connector terminal 10, when viewed in the direction the female connector terminal 10 and the mating terminal are connected.

As illustrated in FIG. 3, the first upper wall 11a and the second upper wall 11e are stacked in an overlapped manner, to form an upper wall 11h. The first side wall 11b and the second side wall 11d are arranged to be opposed nearly in parallel while being spaced. Also the bottom wall 11c and the upper wall 11h are arranged to be opposed nearly in parallel while being spaced. The connection part 11 has a contact point part 11g arranged in a space surrounded by the first side wall 11b, the bottom wall 11c, the second side wall 11d and the upper wall 11h. The female connector terminal 10 thus has an elastic part 11f and a contact point part 11g.

The contact point part 11g is, as illustrated in FIG. 4, connected to the bottom wall 11c, via the elastic part 11f curved nearly in V-shape or nearly in U-shape. The elastic part 11f has elasticity, and is provided so as to fix the male connector terminal 50 (mating connection component) to be connected to the female connector terminal 10 onto the female connector terminal, making use of elastic force attributable to the elasticity. The contact point part 11g is provided so as to be electrically connected to the male connector terminal 50 (mating connection component) to be connected to the female connector terminal 10.

FIG. 5 is a cross-sectional view illustrating an exemplary state of the male connector terminal 50 as the mating connection component, inserted into the female connector terminal 10. As illustrated in FIG. 5, the female connector terminal 10 and the male connector terminal 50 are electrically connected, by inserting a connection part 51 of the male connector terminal 50 into the female connector terminal 10. More specifically, the female connector terminal 10 and the male connector terminal 50 are electrically connected, by inserting the connection part 51 of the male connector terminal 50 between the contact point part 11g and the upper wall 11h, so as to bring a contact point part 51a of the connection part 51 into contact with the contact point part 11g.

When the connection part 51 of the male connector terminal 50 is inserted into the female connector terminal 10 as illustrated in FIG. 5, the contact point part 11g is pressed by the connection part 51 towards the bottom wall 11c, and the elastic part 11f deforms so as to reduce its radius of curvature. The elastic part 11f that manages to restore the original radius of curvature exerts elastic force, so as to push the contact point part 11g back towards the upper wall 11h. More specifically, the upper wall 11h and the contact point part 11g catch the connection part 51 of the male connector terminal 50 in between, with the aid of elastic force of the elastic part 11f which acts to fix the male connector terminal 50.

FIG. 6 is a side elevation illustrating an exemplary cable with terminal having the male connector terminal 50 and the cable 60 crimped thereon. FIG. 7 is a top view illustrating an exemplary cable with terminal having the male connector terminal 50 and the cable 60 crimped thereon. As illustrated in FIGS. 6 and 7, the male connector terminal 50 has the connection part 51 and the crimping part 52. That is, the male connector terminal 50 has the contact point part 51a and the crimping part 52. The connection part 51 is provided at one end of the male connector terminal 50, and the crimping part 52 is provided at other end of the male connector terminal 50. The connection part 51 is provided so as to be electrically connected to the female connector terminal 10. The contact point part 51a is provided so as to be electrically connected to the female connector terminal 10. Within the cable with terminal, the crimping part 52 crimps and fixes the cable 60 that is connected to the male connector terminal 50.

The male connector terminal 50 may be formed from an unillustrated single blank formed of a metal, similarly to the female connector terminal 10. Material for forming the male connector terminal 50 preferably contains at least one metal selected from the group consisting of copper, copper alloy, aluminum, aluminum alloy, iron, iron alloy, magnesium and magnesium alloy. The material forming the male connector terminal 50 may be identical to, or different from, the material forming the female connector terminal 10.

The connection part 51 is formed by stacking metal sheets, and has a nearly rectangular shape. The connection part 51 is provided so as to be electrically connected to the female connector terminal 10. As illustrated in FIGS. 5 and 7, the connection part 51 has the contact point part 51a provided so as to be brought into electrical contact with the contact point part 11g of the female connector terminal 10. More specifically, the female connector terminal 10 and the male connector terminal 50 are electrically connected, as a result of contact between the contact point part 51a of the male connector terminal 50 and the contact point part 11g of the female connector terminal 10.

The crimping part 52 has a conductor crimping part 53 that crimps a conductor 61 of the cable 60, and a sheath crimping part 54 that crimps a cable sheath 62 of the cable 60. The conductor crimping part 53 of the male connector terminal 50 may be formed similarly to the conductor crimping part 14 of the female connector terminal 10. Meanwhile, the sheath crimping part 54 of the male connector terminal 50 may be formed similarly to the sheath crimping part 15 of the female connector terminal 10.

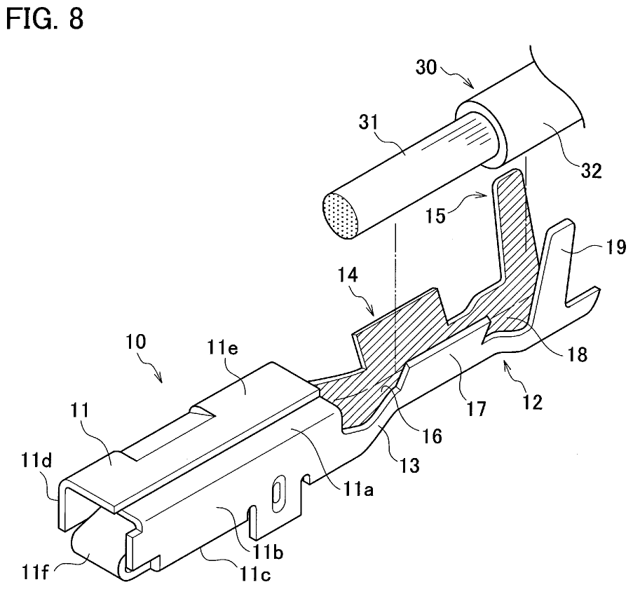

Next, a method for crimping the cable 30 onto the crimping part 12 of the female connector terminal 10 will be explained referring to FIGS. 1 and 8. FIG. 1 illustrates a state that the cable 30 has been crimped onto the crimping part 12. FIG. 8 illustrates a state that the cable 30 has not been crimped yet onto the crimping part 12. The method for crimping the cable 60 onto the crimping part 52 of the male connector terminal 50 is same as the method for crimping the cable 30 onto the crimping part 12 of the female connector terminal 10, and will not therefore be explained again.

As illustrated in FIG. 8, the crimping part 12 is provided so as to crimp and fix the cable 30 that is connected to the female connector terminal 10. Upon insertion of the end of the cable 30 into the crimping part 12 of the female connector terminal 10, the conductor 31 of the cable 30 is placed on the top face of a bottom plate 16 of the conductor crimping part 14, and concurrently a part of the cable 30 surrounded by the cable sheath 32 is placed on the top face of a bottom plate 18 of the sheath crimping part 15.

As illustrated in FIG. 8, the conductor crimping part 14 is designed to come into direct contact with the conductor 31 exposed as a result of removal of the cable sheath 32 at the end of the cable 30, and has the bottom plate 16 and a pair of conductor crimping wings 17. The pair of conductor crimping wings 17 are protruded upward from both edges of the bottom plate 16. The conductor crimping part 14 is formed of the bottom plate 16 and the pair of conductor crimping wings 17 so as to give a nearly U-shape cross section.

The sheath crimping part 15 is designed to come into direct contact with the cable sheath 32 at the end of the cable 30, and has the bottom plate 18 and a pair of sheath crimping wings 19. The pair of sheath crimping wings 19 are protruded upward from both edges of the bottom plate 18. The sheath crimping part 15 is formed of the bottom plate 18 and the pair of sheath crimping wings 19 so as to give a nearly U-shape cross section. Note that the bottom plate 16 of the conductor crimping part 14 and the bottom plate 18 of the sheath crimping part 15 are formed in an integrated manner to give a common bottom plate.

The pair of conductor crimping wings 17 are designed to be bent inwardly, so as to embrace the conductor 31 of the cable 30, and to crimp the conductor 31 while bringing it into close contact with the top face of the bottom plate 16. Meanwhile, the pair of sheath crimping wings 19 are designed to be bent inwardly, so as to embrace the part of the cable 30 surrounded by the cable sheath 32, and to crimp the cable sheath 32 while bringing it into close contact with the top face of the bottom plate 18. The conductor crimping part 14 and the sheath crimping part 15 are deformed by pressurizing the ends of the crimping part 12 and the cable 30. In this way, the female connector terminal 10 and the cable 30 may be connected by crimping, as illustrated in FIG. 1.

The cable 30 has the conductor 31, and the cable sheath 32 that covers the conductor 31.

The conductor 31 may contain an element wire. The conductor 31 may be a single wire, or may be a strand formed by twisting a plurality of (3 to 1500, and 7 for example) element wires, each being a single wire. The conductor 31 is usually a strand. The cable as used herein is a covered wire having a bare strand covered with a freely selectable insulating resin layer. A plurality of such cables, when bundled into one cable and armored, may be referred to as a wire harness.

Materials employable for the conductor 31 are highly conductive metals. For the materials for forming the conductor 31, employable are copper, copper alloy, aluminum and aluminum alloy. In recent years, the cable 30 has been required to reduce the weight. Hence, the conductor 31 is preferably formed of lightweight aluminum or aluminum alloy.

Resins capable of satisfying a necessary level of electrical insulation are employable as a material for forming the cable sheath 32 that covers the conductor 31. Olefinic resins, for example, are employable as the material for forming the cable sheath 32. More specifically, at least one or more resins selected from the group consisting of polyethylene (PE), polypropylene (PP), ethylene copolymer and propylene copolymer may be used as a main component of the material for forming the cable sheath 32. Also polyvinyl chloride (PVC) may be used as a main component of the material forming the cable sheath 32. Among them, polypropylene or polyvinyl chloride is preferably contained as a main component of the material for forming the cable sheath 32, in view of high flexibility and durability. The main component as used herein means a component that accounts for 50% by mass of more of the whole cable sheath 32.

The cable 60 may have the same structure and composition as the cable 30. More specifically, the conductor 61 may have the same structure as the conductor 31. Also the cable sheath 62 may have the same structure and composition as the cable sheath 32.

As described above, the elastic part 11f has elasticity, and is provided so as to fix the male connector terminal 50 onto the female connector terminal 10 with the aid of elastic force attributable to the elasticity. The crimping part 12 is provided so as to crimp and fix the cable 30 that is connected to the female connector terminal 10. Hence, the female connector terminal 10 when heated may unfortunately have reduced elastic force in the elastic part 11f, or may have reduced crimping strength of the crimping part 12 exerted on the cable 30.

This embodiment therefore takes a measure to form a graphene-containing carbon film 80 on the electrical connection component under heating by irradiation of the laser light 72, specifically on a region where the contact point part has been formed, but outside of a region where the elastic part and the crimping part have been formed.

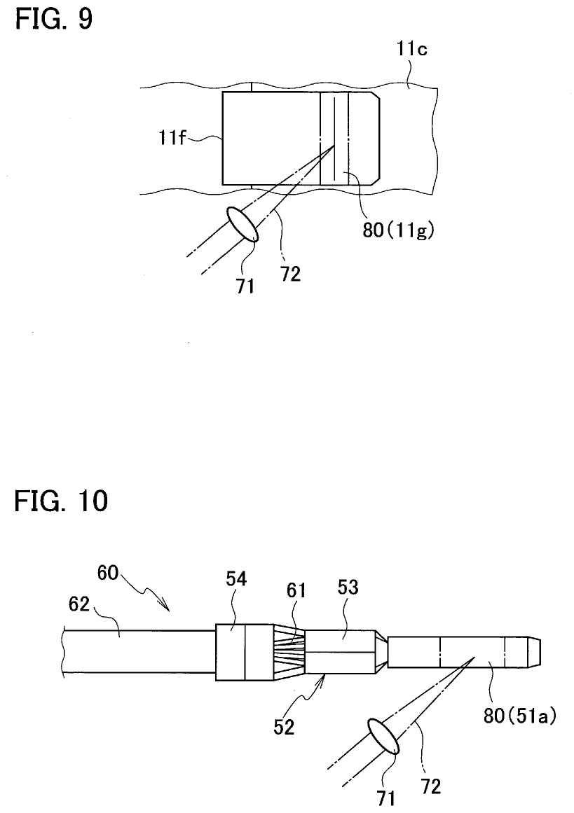

FIG. 9 is a top view illustrating a process of forming the carbon film 80 by irradiating the laser light 72 on the contact point part 11g of the female connector terminal 10. More specifically, the carbon film 80 is formed on the female connector terminal 10 under heating by irradiation of laser 72, specifically on a region where the contact point part 11g has been formed, but outside of a region where the elastic part 11f and the crimping part 12 have been formed. The laser light 72 is condensed, as illustrated in FIG. 9, by a condenser lens 71 onto the female connector terminal 10 for heating. The laser light 72 is now irradiated onto the contact point part 11g, but not onto the elastic part 11f and the crimping part 12. The region irradiated by the laser light 72 may be the contact point part 11g only, but may contain the contact point part 11g as well as a peripheral region around the contact point part 11g.

FIG. 10 is a top view illustrating a process of forming the carbon film 80 by irradiating the laser light 72 on the contact point part 51a of the male connector terminal 50. More specifically, the carbon film 80 is formed on the male connector terminal 50 under heating by irradiation of laser 72, specifically on a region where the contact point part 51a has been formed, but outside of a region where the crimping part 52 has been formed. The laser light 72 is condensed, as illustrated in FIG. 10, by the condenser lens 71 onto the male connector terminal 50 for heating. The laser light 72 is now irradiated onto the contact point part 51a, but not onto the crimping part 52. The region irradiated by the laser light 72 may be the contact point part 51a only, but may contain the contact point part 51a as well as a peripheral region around the contact point part 51a.

The carbon film 80 is formed under heating by irradiation of the laser light 72. The laser light 72 is intrinsically advantageous to condense energy, and can heat the contact point part 11g or the contact point part 51a in a localized manner when irradiated thereon with the laser light 72. Hence the female connector terminal 10 or the male connector terminal 50 is no longer necessary to be heated entirely like in the conventional CVD (chemical vapor deposition) process. The carbon film 80 may therefore be formed on the female connector terminal 10, without heating the elastic part 11f and the crimping part 12. Similarly, the carbon film 80 may be formed on the male connector terminal 50, without heating the crimping part 52.

The carbon film 80 contains graphene. Graphene has a planar hexagonal lattice structure composed of mutually linked sp² carbon atoms. The carbon film 80 may include a monolayer graphene, or may be graphite including a plurality of graphene layers that are mutually stacked.

The carbon film 80 preferably has a thickness of 0.335 nm to 10 μm, from the viewpoint of contact reliability. Note that the lower limit value corresponds to the size of a single carbon atom, and therefore corresponds to the thickness of a graphene monolayer. The thickness of the carbon film 80 may be measured by observing a cross section of the carbon film 80 under a scanning electron microscope (SEM) or under a transmission electron microscope (TEM).

The carbon film 80 may be formed by irradiating the laser light 72 onto a starting material of the carbon film 80. The starting material for the carbon film 80 is not specifically limited so long as it can form the graphene-containing carbon film 80 upon being heated by the laser light 72. The starting material for the carbon film 80 typically includes gas material, liquid material and solid material.

The carbon film 80, when started from a gas material, is preferably formed on the contact point part 11g or the contact point part 51a under heating by irradiation of the laser light 72, in an atmosphere of such gas material. The gas material for forming the carbon film 80 is preferably a carbon-containing gas, including methane gas, ethylene gas, acetylene gas, ethanol gas, acetone gas, methanol gas, and combinations of these gases.

The carbon film 80, when started from a liquid or solid material, is preferably formed by heating the liquid material or, the solid material arranged on the surface of the contact point part 11g or the contact point part 51a, by irradiating thereon the laser light 72.

The liquid or solid material for forming the carbon film 80 is preferably an organic material such as poly(methyl methacrylate) (PMMA), or graphene oxide (GO). The carbon film 80, when started from graphene oxide, is formed by reducing the graphene oxide under heating by irradiation of the laser light 72. The graphene-containing carbon film 80 is thus formed.

The laser light 72 is not specifically limited so long as it can be irradiated on, and can heat, the region where the contact point part 11g or the contact point part 51a is formed, and can form the carbon film 80. The region where the contact point part 11g or the contact point part 51a is formed is heated by irradiation of the laser light 72, for example, up to 300° C. to 400° C. from the viewpoint of reaction efficiency and reaction time of graphene.

The laser light 72 typically has a wavelength of 808 nm or 1064 nm in the near-infrared region, although selected depending on light absorptivity of the material to be irradiated.

The laser light 72 may be irradiated using a known laser light irradiating apparatus. The laser irradiating apparatus may have a laser oscillator, a light path, and a condenser lens 71. The laser light 72 emitted from the laser oscillator is allowed to propagate through the light path typically formed of an optical fiber, condensed by the condenser lens 71, and then irradiated on the region where the contact point part 11g or the contact point part 51a is formed.

The laser oscillator typically has an excitation source, a laser medium, a total reflection mirror, and a partial reflection mirror. The laser medium emits light upon being excited by energy fed from the excitation source. The light emitted in the laser medium is then amplified within the laser medium, while being reflected on each of the total reflection mirror that covers one end of the laser medium and the partial reflection mirror that covers the other end of the laser medium. The amplified light is emitted, as the laser light 72, through the partial reflection mirror.

Method of exciting the laser medium by the excitation source is properly selectable depending for example on types of the laser medium. Excitation of the laser medium by the excitation source include excitation by electric discharge, excitation by light, excitation by energy obtained by chemical reaction, excitation by electric current, and excitation by heat energy.

The laser medium includes gas, liquid, solid and semiconductor, without special limitation. The gas laser medium contains helium-neon (He—Ne) mixed gas, argon (Ar) gas, carbon dioxide (CO₂) gas, and excimer. The liquid laser medium contains a dye such as rhodamine. The solid laser medium contains ruby, glass, and YAG (yttrium aluminum garnet). The semiconductor laser medium includes aluminum gallium arsenide (AlGaAs), indium gallium arsenide phosphide (InGaAsP), aluminum gallium indium phosphide (AlGaInP) and gallium nitride (GaN).

Method of oscillating the laser light 72 is not specifically limited. More specifically, the laser light 72 to be oscillated may be continuous wave (CW) that continuously oscillates at a constant output, or may be pulse wave that intermittently gives pulsed output.

The blank from which the female connector terminal 10 or the male connector terminal 50 is formed may have a substrate formed of a metal. An intermediate layer such as a plating layer may be provided between the substrate and the carbon film 80. Material for forming the intermediate layer is preferably, but not limited to, nickel, cobalt, copper, tin and alloys of these metals. The intermediate layer may be a monolayer or multiple layers. Thickness of the intermediate layer is preferably, but not limited to, 0.01 μm to 10 μm for example.

This embodiment has been explained an exemplary case where the carbon film 80 was formed on the contact point part 11g and the contact point part 51a of the female connector terminal 10 and the male connector terminal 50, respectively, after being bent up. The present disclosure is, however, not limited to such embodiment. For example, the blank before being bent up into the connector terminal may be irradiated by the laser light 72 to form the carbon film 80, in the limited region to be served as the contact point part. This way of forming the carbon film 80 can simplify a process of manufacturing the female connector terminal 10 or the male connector terminal 50.

The present embodiment has been explained the female connector terminal 10 and the male connector terminal 50. Effects same as those as described in this embodiment are, however, obtainable from any other electrical connection component, so long as it has a connection part, and at least one of an elastic part or a crimping part. The electrical connection component having a connection part, and at least one of an elastic part or a crimping part, includes card edge connector, ring terminal, and U-shape terminal, besides the aforementioned connector terminals.

The card edge connector is a connector typically used for circuit board. The ring terminal is a terminal having a ring-shape connection part through which electrical connection with a mating connection component is established with the aid of a fixture such as screw. The U-shape terminal is a terminal having a U-shape connection part through which electrical connection with a mating connection component is established with the aid of a fixture such as screw.

A method for manufacturing an electrical connection component according to the present embodiment relates to a method of manufacturing an electrical connection component that has at least either one of an elastic part or a crimping part, and a contact point part. The elastic part has elasticity, and is provided so as to fix a mating connection component to be connected to the electrical connection component onto the electrical connection component, making use of elastic force attributable to the elasticity. The crimping part is provided so as to crimp and fix a cable that is connected to the electrical connection component. The contact point part is provided so as to be electrically connected to the mating connection component. The method includes forming a graphene-containing carbon film 80 on the electrical connection component under heating by irradiation of the laser light 72, on a region where the contact point part will be formed or has been formed, but outside of a region where the elastic part and the crimping part will be formed or have been formed.

The electrical connection component may be either one of the female connector terminal 10 or the male connector terminal 50. Meanwhile, the mating connection component may be a male connector terminal 50 if the electrical connection component is the female connector terminal 10, and may be a female connector terminal 10 if the electrical connection component is the male connector terminal 50.

The female connector terminal 10 may have the contact point part 11g and the elastic part 11f. Meanwhile, the male connector terminal 50 may have the contact point part 51a and the crimping part 52.

As described previously, the method for manufacturing an electrical connection component according to this embodiment is designed to form the graphene-containing carbon film 80 on the electrical connection component, on the contact point part, but outside of the elastic part and the crimping part. Hence, the electrical connection component manufactured by the method of manufacturing an electrical connection component according to this embodiment can improve the contact reliability with the mating connection component, and can improve the wear resistance at the contact point part with the mating connection component, without using expensive noble metals.

The method for manufacturing an electrical connection component according to this embodiment is designed to form the graphene-containing carbon film 80, under heating by irradiation of the laser light 72. This makes it possible to heat only a necessary region with the laser light 72, rather than to heat the entire region of the electrical connection component like in the conventional CVD process. More specifically, the carbon film 80 is formed on the contact point part of the electrical connection component, rather than on the elastic part and the crimping part, under heating by irradiation of the laser light 72.

The method for manufacturing an electrical connection component according to this embodiment can therefore suppress degradation of elastic force in the elastic part of the electrical connection component, or degradation of crimping strength exerted on the cable. The method for manufacturing an electrical connection component according to this embodiment can therefore provide an electrical connection component capable of improving contact reliability, as compared with the conventional CVD process.

Time for forming the carbon film 80 usually depends on the area of formation of film. The method for manufacturing an electric connection part can form the carbon film 80 only in a region where the carbon film 80 is necessary, using the laser light 72. Hence, the area over which the carbon film 80 is formed will not be excessively large, making it possible to shorten the time for manufacturing the electrical connection component.

Having explained the present embodiment, the present disclosure is by no means limited to such embodiment, instead allowing various modifications without departing from the spirit of the present disclosure.

What is claimed is:

1. A method for manufacturing an electrical connection component,
the electrical connection component comprising at least either one of an elastic part or a crimping part, and a contact point part,
the elastic part having elasticity, and being provided so as to fix a mating connection component to be connected to the electrical connection component onto the electrical connection component, making use of elastic force attributable to the elasticity,
the crimping part being provided so as to crimp and fix a cable connected to the electrical connection component,
the contact point part being provided so as to be electrically connected to the mating connection component,
the method comprising:
forming a graphene-containing carbon film on the electrical connection component under heating by irradiation of laser light, on a region where the contact point part will be formed or has been formed, but outside of a region where the elastic part and the crimping part will be formed or have been formed.

2. The method for manufacturing an electrical connection component according to claim 1,
wherein the electrical connection component is either one of a female connector terminal or a male connector terminal, and
the mating connection component is a male connector terminal if the electrical connection component is the female connector terminal, and is a female connector terminal if the electrical connection component is the male connector terminal.

3. The method for manufacturing an electrical connection component according to claim 2,
wherein the female connector terminal has the contact point part and the elastic part, and
the male connector terminal has the contact point part and the crimping part.
